(19) United States
(12) Patent Application Publication
(10) Pub. No.: US 2012/0176346 A1
(43) Pub. Date: Jul. 12, 2012

(54) SOURCE DRIVER

(75) Inventor: Meng-Tse Weng, Tainan County (TW)

(73) Assignee: HIMAX TECHNOLOGIES LIMITED, Tainan County (TW)

(21) Appl. No.: 13/004,259

(22) Filed: Jan. 11, 2011

(51) Int. Cl. G09G 5/00; G09G 3/36

(52) U.S. Cl. 345/204; 345/98

(57) ABSTRACT

A source driver including a presetting unit and a driving unit is provided. The presetting unit receives a plurality of display data and outputs the display data or a plurality of black insertion data according to a black insertion control signal. The driving unit receives the display data or the black insertion data in accordance with the operation of the presetting unit. Furthermore, the driving unit converts the display data into a plurality of display signals, and converts the black insertion data into a plurality of black insertion signals.

### BACKGROUND OF THE INVENTION

1. Field of the Invention

The invention relates generally to a source driver, and more particularly to a source driver having a black insertion control function.

2. Description of Related Art

In recent years, due to the liquid crystal display (LCD) having properties such as high image quality, compactness, low power consumption, and radiation-free, it has gradually replaced the conventional cathode ray tube (CRT) display and became the main stream of the current display market. Nowadays, LCDs have been widely applied in consumer electronic products such as televisions and mobile equipments. Among other functions, the displays in these products must provide real-time images, and so unavoidably, dynamic images are frequently displayed.

Generally speaking, a phenomenon of motion blur occurs when playing back dynamic images on the LCD, for instance when the outline of the images appears unclear or the images become slurred. The motion blur phenomenon is mainly due to the relatively slow response speed of the liquid crystals and the hold-type emissive mode of the LCD. Therefore, since the human eye operates in an integrating mode, when a user watches the dynamic images played back by the LCD, issues such as edge blur are generated in the displayed images.

Nowadays, LCDs largely adopt a black insertion method to mitigate the motion blur issue, and a black insertion frame is usually provided by a front end control unit of the display for a back end source driver. However, this design framework of the front end control unit providing the black insertion frame usually leads to an overly complex front end control of the display, and thus adding to the hardware cost of the system.

### SUMMARY OF THE INVENTION

An aspect of the invention provides a source driver capable of using a presetting unit to generate a black insertion data, so as to self-provide a black insertion frame. Accordingly, a circuit structure of a front end control unit of a display can be reduced, thereby lowering a system cost of the display.

An embodiment of the invention provides a source driver including a presetting unit and a driving unit. The presetting unit receives a plurality of display data and outputs the display data or a plurality of black insertion data according to a black insertion control signal. Moreover, the driving unit receives the display data or the black insertion data in accordance with the operation of the presetting unit. In addition, the driving unit converts the display data into a plurality of display signals, and converts the black insertion data into a plurality of black insertion signals.

According to an embodiment of the invention, the display data includes a first display data, the black insertion data includes a first black insertion data, and the presetting unit includes a first switch and a first latch. The first switch has a first terminal receiving the first display data, a second terminal receiving a black data, and a third terminal conducted to the first terminal or the second terminal of the first switch according to the black insertion control signal, so as to output the first display data or the black data. The first latch is electrically connected to the third terminal of the first switch. Moreover, the first latch latches the first display data or the black data from the first switch, and according to a first latch signal, the first latch determines whether to output the first display data or the first black insertion data formed by the black data.

According to an embodiment of the invention, the display data includes a third display data, the black insertion data includes a third black insertion data, and the presetting unit includes a third latch and a third switch. The third latch receives and latches the third display data, and according to a third latch signal, the third latch determines whether to output the third display data. A first terminal of the third switch receives the third display data from the third latch. A second terminal of the third switch receives a black data. A third terminal of the third switch is conducted to the first terminal or the second terminal of the third switch according to the black insertion control signal, so as to output the third display data or the third black insertion data formed by the black data.

According to an embodiment of the invention, the display data includes a fifth display data, the black insertion data includes a fifth black insertion data, and the presetting unit includes a fifth latch and a first logic circuit. The fifth latch receives and latches the, fifth display data, and according to a fifth latch signal, the fifth latch determines whether to output the fifth display data. The first logic circuit performs a logic operation on the fifth display data from the fifth latch and the black insertion control signal, so as to output the fifth display data or the fifth black insertion data.

According to an embodiment of the invention, the display data includes a seventh display data, the black insertion data includes a seventh black insertion data, and the presetting unit includes a third logic circuit latch and a seventh latch. The third logic circuit performs a logic operation on the seventh display data and the black insertion control signal, so as to generate the seventh display data or the seventh black insertion data. The seventh latch receives and latches the seventh display data or the seventh black insertion data from the third logic circuit, and according to a seventh latch signal, the seventh latch determines whether to output the seventh display data or the seventh black insertion data.

In summary, according to embodiments of the invention, the presetting unit in the source driver determines whether to generate the black insertion data according to the black insertion control signal. Accordingly, the presetting unit may output the black insertion data or the received display data. In other words, the source driver according to embodiments of the invention may self-provide a black insertion frame, thereby reducing the circuit structure of the front end control unit in the display.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a source driver according to an embodiment of the invention.

FIG. 2 is a schematic block diagram of a source driver according to another embodiment of the invention.

FIG. 3 is a schematic block diagram of a source driver according to another embodiment of the invention.

FIG. 4 is a schematic block diagram of a source driver according to another embodiment of the invention.

### DESCRIPTION OF EMBODIMENTS

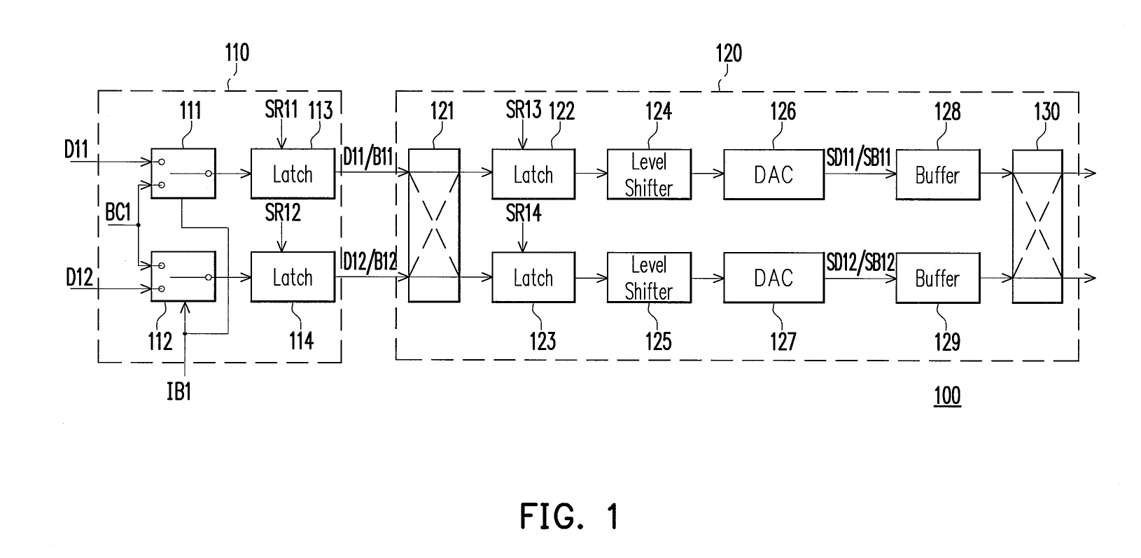

FIG. 1 is a schematic block diagram of a source driver according to an embodiment of the invention. Referring to FIG. 1, a source driver 100 includes a presetting unit 110 and a driving unit 120. In an overall operation, the presetting unit 110 receives a plurality of display data D11 and D12, and the presetting unit 110 determines whether to generate a plurality of black insertion data B11 and B12 according to a black insertion control signal IB1. Accordingly, the presetting unit 110 may output the display data D11 and D12 or the plurality of black insertion data B11 and B12. The black insertion control signal IB1 originates from a front end control unit of a display, for example a timing controller.

When the presetting unit 110 outputs the display data D11 and D12, the driving unit 120 converts the display data D11 and D12 into a plurality of corresponding display signals. Conversely, when the presetting unit 110 outputs the black insertion data B11 and B12, the driving unit 120 converts the black insertion data B11 and B12 into a plurality of corresponding black insertion signals. In other words, the driving unit 120 receives the display data D11 and 12 or the black insertion data B11 and B12 in accordance with the operation of the presetting unit 110, and the driving unit 120 converts the received data into the corresponding signals, so as to drive the pixels at the back end (not drawn).

Accordingly, the source driver 100 may self-provide a black insertion frame, thereby reducing a circuit structure of the front end control unit in the display. Therefore, the source driver 100 in the embodiment is effective in reducing a system cost of the display. In order for people having ordinary skill in the art to better understand the invention, detailed structures of the presetting unit 110 and the driving unit 120 are further illustrated in the following.

Referring to FIG. 1, the presetting unit 110 includes a plurality of switches 111 and 112 and a plurality of latches 113 and 114. The switch 111 has a first terminal receiving the display data D11, a second terminal receiving a black data BC1, and a third terminal electrically connected to the latch 113. The switch 112 has a first terminal receiving the display data D12, a second terminal receiving a black data BC1, and a third terminal electrically connected to the latch 114.

During operation, the third terminal of the switch 111 is conducted to the first terminal or the second terminal of the switch 111 according to the black insertion control signal IB1. Accordingly, one of the display data D11 and the black data BC1 is transmitted to the latch 113. When the display data D11 is transmitted to the latch 113, the latch 113 latches the display data D11 and determines whether to output the display data D11 according to a latch signal SR11. Moreover, when the black data BC1 is transmitted to the latch 113, the latch 113 latches the black data BC1, and according to a latch signal SR11, the latch 113 determines whether to output the black insertion data B11 formed by the black data BC1.

On the other hand, the third terminal of the switch 112 is conducted to the first terminal or the second terminal of the switch 112 according to the black insertion control signal IB1. Accordingly, one of the display data D12 and the black data BC1 is transmitted to the latch 114. Therefore, when the display data D12 is transmitted to the latch 114, the latch 114 latches the display data D12, and accordingly to a latch signal SR12, the latch 114 determines whether to output the display data D12. Further, when the black data BC1 is transmitted to the latch 114, the latch 114 latches the black data BC1, and according to the latch signal SR12, the latch 114 determines whether to output the black insertion data B12 formed by the black data BC1.

Continuing reference to FIG. 1, the driving unit 120 includes a plurality of multiplexers 121 and 130, a plurality of latches 122 and 123, a plurality of level shifters 124 and 125, a plurality of digital-to-analog converters (DACs) 126 and 127, and a plurality of buffers 128 and 129. The multiplexer 121 has a first through fourth connecting terminals, the first and second connecting terminals of the multiplexer 121 receiving the display data D11 and D12 or the black insertion data B11 and B12. Moreover, the multiplexer 121 respectively conducts the first and second connecting terminals thereof to the third and fourth connecting terminals thereof, or the multiplexer 121 respectively conducts the first and second connecting terminals thereof to the fourth and third connecting terminals thereof.

The latch 122 is electrically connected to the third connecting terminal of the multiplexer 121, and according to a latch signal SR13, the latch 122 determines whether to output the data from the third connecting terminal of the multiplexer 121. In addition, the latch 123 is electrically connected to the fourth connecting terminal of the multiplexer 121, and according to a latch signal SR14, the latch 123 determines whether to output the data from the fourth connecting terminal of the multiplexer 121.

The level shifter 124 is electrically connected to the latch 122, and the level shifter 124 adjusts a level of the data outputted by the latch 122, so as to drive an internal switch of the DAC 126 at the back end. Moreover, the DAC 126 is electrically connected to the level shifter 124, and the DAC 126 converts the data outputted by the level shifter 124 into an analog signal, so as to generate a display signal SD11 or a black insertion signal SB11. For example, when the presetting unit 110 outputs the display data D11 and D12, the DAC 126 generates the display signal SD11. Conversely, when the presetting unit 110 outputs the black insertion data B11 and B12, the DAC 126 generates the black insertion signal SB11.

Similarly, the level shifter 125 is electrically connected to the latch 123, and the level shifter 125 adjusts a level of the data outputted by the latch 123, so as to push an internal switch of the DAC 127 at the back end. The DAC 127 is electrically connected to the level shifter 125, and the DAC 127 converts the data outputted by the level shifter 125 into an analog signal, so as to generate a display signal SD12 or a black insertion signal SB 12. For example, when the presetting unit 110 outputs the display data D11 and D12, the DAC 127 generates the display signal SD12. Conversely, when the presetting unit 110 outputs the black insertion data B11 and B12, the DAC 127 generates the black insertion signal SB12.

The switching of the multiplexer 121 determines a corresponding relationship between the display signals SD11 and SD12 and the display data D11 and D12, as well as a corresponding relationship between the black insertion signals SB11 and SB12 and the black insertion data B11 and B12. For example, when the presetting unit 110 outputs the display data D11 and D12, and the first and second connecting terminals of the multiplexer 121 are respectively conducted to the third and fourth terminals thereof, then the display signal SD11 is the signal obtained after the driving unit 120 converts the display data D11, and the display signal SD12 is the signal obtained after the driving unit 120 converts the display data D12. Conversely, when the presetting unit 110 outputs the display data D11 and D12, and the first and second connecting terminals of the multiplexer 121 are respectively conducted to the fourth and third terminals thereof, then the display signal SD11 is the signal obtained after the driving unit 120 converts the display data D12, and the display signal SD12 is the signal obtained after the driving unit 120 converts the display data D11. The circumstance for the corresponding relationship between the black insertion signals SB11 and SB12 and the black insertion data B11 and B12 may be obtained in a way similar to that described above.

Moreover, the buffer 128 is electrically connected to the DAC 126, and the buffer 128 amplifies the display signal SD11 or the black insertion signal SB11. In addition, the buffer 129 is electrically connected to the DAC 129, and the buffer 129 amplifies the display signal SD12 or the black insertion signal SB12. It should be noted that, in the embodiment, the DAC 126 and 127 are used to generate display signals SD11 and SD12 having different polarities. Therefore, to achieve the polarity switching, the display signals SD11 and SD12 must be switched by the multiplexer 130 before being provided to the pixels at the back end.

The multiplexer 130 has a first through fourth connecting terminals, and the first and second connecting terminals of the multiplexer 130 are respectively electrically connected to the buffers 128 and 129, so as to receive the display signals SD11 and SD12 or the black insertion signals SB11 and SB12 after amplification. Further, the multiplexer 130 respectively conducts the first and second connecting terminals thereof to the third and fourth connecting terminals thereof, or the multiplexer 130 respectively conducts the first and second connecting terminals thereof to the fourth and third connecting terminals thereof, so as to perform the polarity switching of the signals.

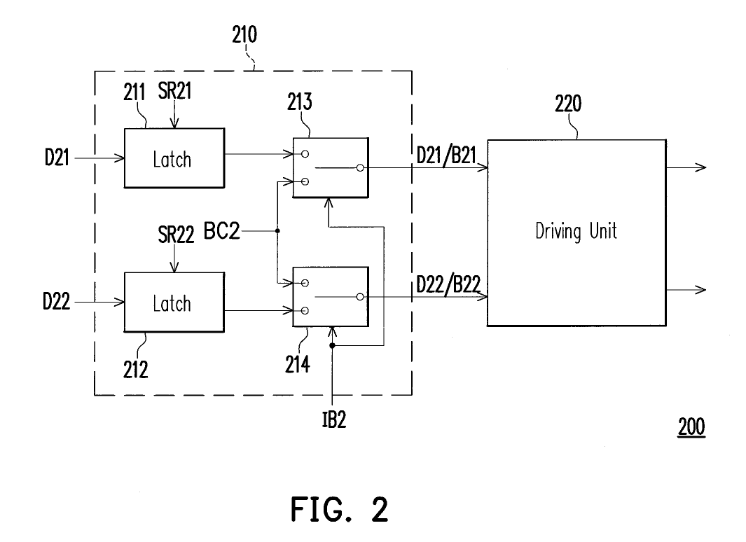

FIG. 2 is a schematic block diagram of a source driver according to another embodiment of the invention. Referring to FIG. 2, a source driver 200 includes a presetting unit 210 and a driving unit 220. In an overall operation, the presetting unit 210 receives a plurality of display data D21 and D21, and the presetting unit 210 outputs the display data D21 and D22 or a plurality of black insertion data B21 and B22 according to a black insertion control signal IB2. The black insertion control signal IB2 originates from a front end control unit of the display, for example a timing controller.

On the other hand, the driving unit 220 receives the display data D21 and D22 or the black insertion data B21 and B22 in accordance with the operation of the presetting unit 210, and the driving unit 220 converts the received data into the corresponding signals, so as to drive the pixels at the back end (not drawn). In other words, the source driver 200 may self-provide a black insertion frame, thereby reducing the system cost of the display. In addition, the detailed structures of the driving unit 220 in the present embodiment is the same or similar to the driving unit 120 in the embodiment depicted in FIG. 1, hence further description thereof is omitted hereafter. The detailed structures of the presetting unit 210 is illustrated in the following.

Referring to FIG. 2, the presetting unit 210 includes a plurality of latches 211 and 212 and a plurality of switches 213 and 214. The latch 211 receives and latches the display data D21, and according to a latch signal SR21, the latch 211 determines whether to output the display data D21. Similarly, the latch 212 receives and latches the display data D22, and according to a latch signal SR22, the latch 212 determines whether to output the display data D22. Moreover, the switch 213 has a first terminal receiving the display data D21 from the latch 211, a second terminal receiving a black data BC2, and a third terminal electrically connected to the driving unit 220. In addition, the switch 214 has a first terminal receiving the display data D22 from the latch 212, a second terminal receiving a black data BC2, and a third terminal electrically connected to the driving unit 220.

During operation, the third terminal of the switch 213 is conducted to the first terminal or the second terminal of the switch 213 according to the black insertion control signal IB2. Accordingly, the switch 213 may transmit the display data D21 or the black insertion data B21 formed by the black data BC2 to the driving unit 220. On the other hand, the third terminal of the switch 214 is conducted to the first terminal or the second terminal of the switch 214 according to the black insertion control signal IB2. Accordingly, the switch 214 may transmit the display data D22 or the black insertion data B22 formed by the black data BC2 to the driving unit 220.

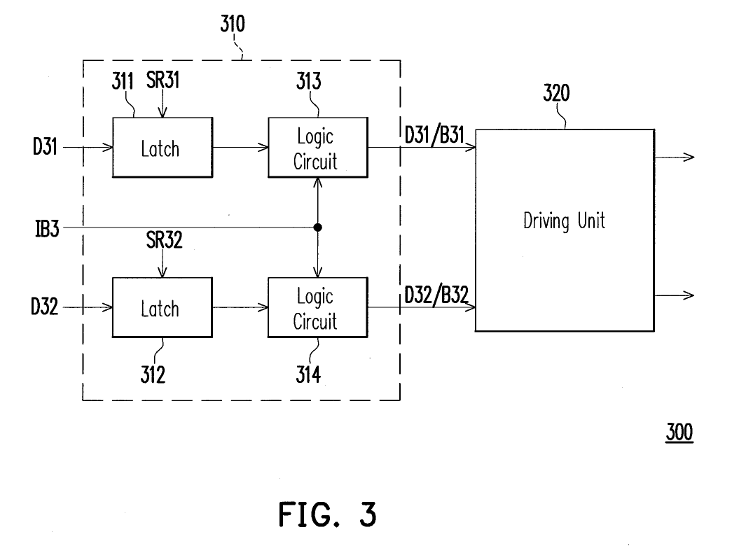

FIG. 3 is a schematic block diagram of a source driver according to another embodiment of the invention. Referring to FIG. 3, a source driver 300 includes a presetting unit 310 and a driving unit 320. In an overall operation, the presetting unit 310 receives a plurality of display data D31 and D32, and the presetting unit 310 outputs the display data D31 and D32 or a plurality of black insertion data B31 and B32 according to a black insertion control signal IB3. The black insertion control signal IB3 originates from a front end control unit of the display, for example a timing controller.

On the other hand, the driving unit 320 receives the display data D31 and D32 or the black insertion data B31 and B32 in accordance with the operation of the presetting unit 310, and the driving unit 320 converts the received data into the corresponding signals, so as to drive the pixels at the back end (not drawn). In other words, the source driver 300 may self-provide a black insertion frame, thereby reducing the system cost of the display. In addition, the detailed structures of the driving unit 320 in the present embodiment is the same or similar to the driving unit 120 in the embodiment depicted in FIG. 1, hence further description thereof is omitted hereafter. The detailed structures of the presetting unit 310 is illustrated in the following.

Referring to FIG. 3, the presetting unit 310 includes a plurality of latches 311 and 312 and a plurality of logic circuits 313 and 314. The latch 311 receives and latches the display data D31, and according to a latch signal S31, the latch 311 determines whether to output the display data D31. Moreover, the logic circuit 313 performs a logic operation on the display data D31 from the latch 311 and the black insertion control signal IB3. The logic operation may be, for example, an AND operation or an OR operation. For instance, when the black insertion control signal IB3 switches to a logic 0, the presetting unit 310 generates the black insertion data B31, and the logic operation at this time may be an AND operation, for example. Accordingly, after the AND operation is performed with the display data D31 and the logic 0, the logic circuit 313 may generate the black insertion data B31 formed by the logic 0. After the AND operation is performed on the display data D31 and a logic 1, the logic circuit 313 may accordingly output the display data D31.

On the other hand, the latch 312 receives and latches the display data D32, and according to a latch signal SR32, the latch 312 determines whether to output the display data D32. Moreover, the logic circuit 314 performs a logic operation on the display data D32 from the latch 312 and the black insertion control signal IB3, so as to output the display data D32 or the black insertion data B32. The logic operation may be, for example, an AND operation or an OR operation. In addition, the operation of the latch 312 and the latch 311 are similar, and the operation of the logic circuit 314 and the logic circuit 313 are similar, hence further description thereof is omitted hereafter.

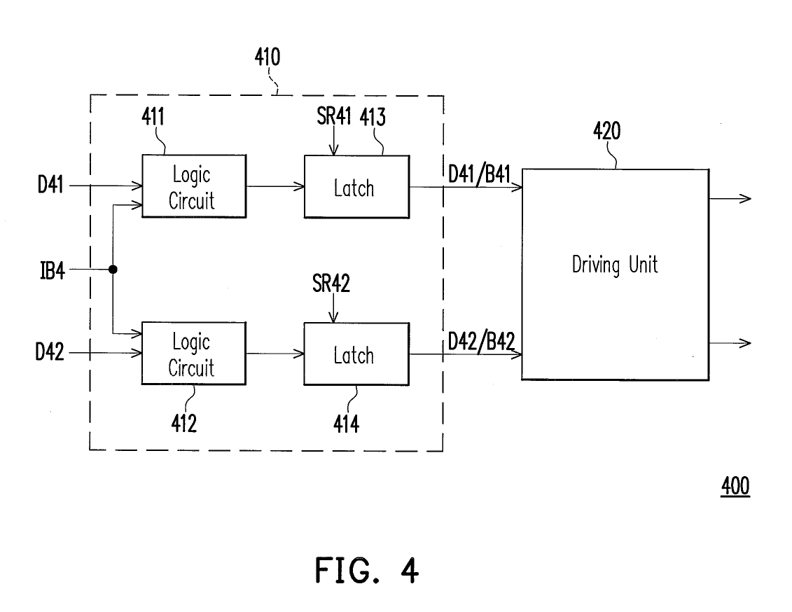

FIG. 4 is a schematic block diagram of a source driver according to another embodiment of the invention. Referring to FIG. 4, a source driver 400 includes a presetting unit 410 and a driving unit 420. In an overall operation, the presetting unit 410 receives a plurality of display data D41 and D42, and the presetting unit 410 outputs the display data D41 and D42 or a plurality of black insertion data B41 and B42 according to a black insertion control signal IB4. The black insertion control signal IB4 originates from a front end control unit of the display, for example a timing controller.

On the other hand, the driving unit 420 receives the display data D41 and D42 or the black insertion data B41 and B42, and the driving unit 420 converts the received data into the corresponding signals, so as to drive the pixels at the back end (not drawn). In other words, the source driver 400 may self-provide a black insertion frame, thereby reducing the system cost of the display. In addition, the detailed structures of the driving unit 420 in the present embodiment is the same or similar to the driving unit 120 in the embodiment depicted in FIG. 1, hence further description thereof is omitted hereafter. The detailed structures of the presetting unit 410 is illustrated in the following.

Referring to FIG. 4, the presetting unit 410 includes a plurality of logic circuits 411 and 412 and a plurality of latches 413 and 414. The logic circuit 411 performs a logic operation on the display data D41 and the black insertion control signal IB4, so as to output the display data D41 or the black insertion data B41. The logic operation may be, for example, an AND operation or an OR operation. For instance, when the black insertion control signal IB4 switches to the logic 0, the presetting unit 410 generates the black insertion data B41, and the logic operation at this time may be an AND operation, for example. Accordingly, after the AND operation is performed on the display data D41 and the logic 0, the logic circuit 411 may generate the black insertion data B41 formed by the logic 0. After the AND operation is performed on the display data D41 and the logic 1, the logic circuit 411 may accordingly output the display data D41.

Similarly, the logic circuit 412 performs a logic operation on the display data D42 and the black insertion control signal IB4, so as to output the display data D42 or the black insertion data B42. The logic operation may be, for example, an AND operation or an OR operation. On the other hand, the latch 413 receives and latches the display data D41 or the black insertion data B41 from the logic circuit 411, and according to a latch signal SR41, the latch 413 determines whether to output the display data D41 or the black insertion data B41. In addition, the latch 414 receives and latches the display data D42 or the black insertion data B42 from the logic circuit 412, and according to a latch signal SR42, the latch 414 determines whether to output the display data D42 or the black insertion data B42.

In view of the foregoing, the source driver according to embodiments of the invention receives a black insertion control signal and a plurality of display data. Moreover, the presetting unit in the source driver determines whether to generate the black insertion data according to the black insertion control signal. Accordingly, the presetting unit may output the black insertion data or the received display data. In other words, the source driver according to embodiments of the invention may self-provide a black insertion frame, thereby reducing the circuit structure of the front end control unit in the display.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A source driver, comprising:
a presetting unit receiving a plurality of display data and outputting the display data or a plurality of black insertion data according to a black insertion control signal; and
a driving unit receiving the display data or the black insertion data in accordance with the operation of the presetting unit, the driving unit converting the display data into a plurality of display signals, and converting the black insertion data into a plurality of black insertion signals.

2. The source driver as claimed in claim 1, wherein the display data comprise a first display data, the black insertion data comprise a first black insertion data, the presetting unit comprising:
a first switch having a first terminal receiving the first display data, a second terminal receiving a black data, and a third terminal conducted to the first terminal or the second terminal of the first switch according to the black insertion control signal, so as to output the first display data or the black data; and
a first latch electrically connected to the third terminal of the first switch, the first latch latching the first display data or the black data from the first switch, and the first latch determining whether to output the first display data or the first black insertion data formed by the black data according to a first latch signal.

3. The source driver as claimed in claim 2, wherein the display data further comprises a second display data, the black insertion data further comprises a second black insertion data, the presetting unit further comprising:
a second switch having a first terminal receiving the second display data, a second terminal receiving the black data, and a third terminal conducted to the first terminal or the second terminal of the second switch according to the black insertion control signal, so as to output the second display data or the black data; and
a second latch electrically connected to the third terminal of the second switch, the second latch latching the second display data or the black data from the second switch, and the second latch determining whether to output the second display data or the second black insertion data formed by the black data according to a second latch signal.

4. The source driver as claimed in claim 1, wherein the display data comprise a third display data, the black insertion data comprise a third black insertion data, the presetting unit comprising:
a third latch receiving and latching the third display data, wherein the third latch determines whether to output the third display data according to a third latch signal; and
a third switch having a first terminal receiving the third display data from the third latch, a second terminal receiving a black data, and a third terminal conducted to the first terminal or the second terminal of the third switch according to the black insertion control signal, so as to output the third display data or the third black insertion data formed by the black data.

5. The source driver as claimed in claim 4, wherein the display data further comprises a fourth display data, the black insertion data further comprises a fourth black insertion data, the presetting unit further comprising:
a fourth latch receiving and latching the fourth display data, wherein the fourth latch determines whether to output the fourth display data according to a fourth latch signal; and
a fourth switch having a first terminal receiving the fourth display data from the fourth latch, a second terminal receiving the black data, and a third terminal conducted to the first terminal or the second terminal of the fourth switch according to the black insertion control signal, so as to output the fourth display data or the fourth black insertion data formed by the black data.

6. The source driver as claimed in claim 1, wherein the display data comprise a fifth display data, the black insertion data comprise a fifth black insertion data, the presetting unit comprising:
a fifth latch receiving and latching the fifth display data, wherein the fifth latch determines whether to output the fifth display data according to a fifth latch signal; and
a first logic circuit performing a logic operation on the fifth display data from the fifth latch and the black insertion control signal, so as to output the fifth display data or the fifth black insertion data.

7. The source driver as claimed in claim 6, wherein the display data further comprises a sixth display data, the black insertion data further comprises a sixth black insertion data, the presetting unit further comprising:
a sixth latch receiving and latching the sixth display data, wherein the sixth latch determines whether to output the sixth display data according to a sixth latch signal; and
a second logic circuit performing the logic operation on the sixth display data from the sixth latch and the black insertion control signal, so as to output the sixth display data or the sixth black insertion data.

8. The source driver as claimed in claim 6, wherein the logic operation is an AND operation or an OR operation.

9. The source driver as claimed in claim 1, wherein the display data comprise a seventh display data, the black insertion data comprise a seventh black insertion data, the presetting unit comprising:
a third logic circuit performing a logic operation on the seventh display data and the black insertion control signal, so as to accordingly generate the seventh display data or the seventh black insertion data; and
a seventh latch receiving and latching the seventh display data or the seventh black insertion data from the third logic circuit, wherein the seventh latch determines whether to output the seventh display data or the seventh black insertion data according to a seventh latch signal.

10. The source driver as claimed in claim 9, wherein the display data further comprise an eighth display data, the black insertion data further comprise an eighth black insertion data, the presetting unit further comprising:
a fourth logic circuit performing the logic operation on the eighth display data and the black insertion control signal, so as to accordingly generate the eighth display data or the eighth black insertion data; and
an eighth latch receiving and latching the eighth display data or the eighth black insertion data from the fourth logic circuit, wherein the eighth latch determines whether to output the eighth display data or the eighth black insertion data according to an eighth latch signal.

11. The source driver as claimed in claim 9, wherein the logic operation is an AND operation or an OR operation.

12. The source driver as claimed in claim 1, wherein the display signals comprise a first display signal and a second display signal, the black insertion signals comprise a first black insertion signal and a second black insertion signal, the driving unit comprising:
a first multiplexer having a first through fourth connecting terminals, the first and second connecting terminals of the first multiplexer receiving two of the display data or two of the black insertion data, wherein the first multiplexer respectively conducts the first and second connecting terminals thereof to the third and fourth connecting terminals thereof, or the first multiplexer respectively conducts the first and second connecting terminals thereof to the fourth and third connecting terminals thereof;
a ninth latch electrically connected to the third connecting terminal of the first multiplexer, wherein the ninth latch determines whether to output the data from the third connecting terminal of the first multiplexer according to a ninth latch signal;
a tenth latch electrically connected to the fourth connecting terminal of the first multiplexer, wherein the tenth latch determines whether to output the data from the fourth connecting terminal of the first multiplexer according to a tenth latch signal;
a first level shifter electrically connected to the ninth latch, the first level shifter adjusting a level of the data outputted by the ninth latch;
a second level shifter electrically connected to the tenth latch, the second level shifter adjusting a level of the data outputted by the tenth latch;
a first digital-to-analog converter (DAC) electrically connected to the first level shifter, the first DAC converting the data outputted by the first level shifter into an analog signal, so as to generate the first display signal or the first black insertion signal;
a second DAC electrically connected to the second level shifter, the second DAC converting the data outputted by the second level shifter into an analog signal, so as to generate the second display signal or the second black insertion signal; and
a second multiplexer having a first through fourth connecting terminals, the first and second connecting terminals of the second multiplexer receiving the first and second display signal or the first and second black insertion signal, wherein the second multiplexer respectively conducts the first and second connecting terminals thereof to the third and fourth connecting terminals thereof, or the second multiplexer respectively conducts the first and second connecting terminals thereof to the fourth and third connecting terminals thereof.

13. The source driver as claimed in claim 12, wherein the driving unit further comprises:
a first buffer electrically connected between the first DAC and the first connecting terminal of the second multiplexer, the first buffer amplifying the first display signal or the first black insertion signal; and
a second buffer electrically connected between the second DAC and the second connecting terminal of the second multiplexer, the second buffer amplifying the second display signal or the second black insertion signal.
